(19) United States
(12) Patent Application Publication
(10) Pub. No.: US 2011/0265629 A1
(43) Pub. Date: Nov. 3, 2011

(54) BRIDGE APPARATUS FOR STRINGED INSTRUMENT

(76) Inventor: Allan Rice, Venice, CA (US)

(21) Appl. No.: 13/120,922

(22) PCT Filed: Sep. 9, 2009
(86) PCT No.: PCT/AU09/01183

§ 371 Date: Mar. 25, 2011

(30) Foreign Application Priority Data
Oct. 2, 2008 (AU) 2008905125

(51) Int. Cl. G10D 3/04

(52) U.S. Cl. 84/307

(57) ABSTRACT

According to the present invention, there is provided a floating bridge apparatus adapted to be mounted on a guitar having strings, the floating bridge apparatus including: a base element and a top element operatively connected to one another for relative movement therebetween which causes vibrato or like pitch-change in the strings, the base element mountable to a deck of the guitar; and a suspension apparatus for controlling the relative movement between the base and top elements, wherein the suspension apparatus is accessible from a position above the deck.

### FIELD OF THE INVENTION

The present invention relates generally to stringed instruments, and in particular, guitars. In addition, the invention concerns bridges for stringed instruments, and apparatus for maintaining floating tension in guitars and other stringed instruments.

### BACKGROUND TO THE INVENTION

It is known to provide a floating bridge in a guitar for providing vibrato, however the arrangement which is known has limitations, in that installation requires a large volume, in particular below the deck of the guitar to which it is being applied. Furthermore, tensioning and varying the tension on the known floating bridges is not possible.

The present invention seeks to ameliorate one or more of the abovementioned disadvantages.

### SUMMARY OF THE INVENTION

According to one aspect of the present invention there is provided a floating bridge apparatus adapted to be mounted on a guitar having strings, the floating bridge apparatus including: a base element and a top element operatively connected to one another for relative movement therebetween which causes vibrato or like pitch-change in the strings, the base element mountable to a deck of the guitar; and a suspension apparatus for controlling the relative movement between the base and top elements, wherein the suspension apparatus is accessible from a position above the deck.

The arrangement may be such that the base and top elements are adapted to pivot relative to one another about a pivot axis. Preferably the top element is pivotally moveable relative to the base element. A pivoting joint may be provided between the base and top elements which may be in the form of an axle and bore, but preferably includes a recess or a bight for receiving a pivoting element, and the pivoting element itself. The recess or bight may be mounted on one of the base element or the top element, while the pivoting element may be mounted on the other of the base element or the top element. Preferably, the recess is associated with the base element while the pivoting element is associated with the top element.

Preferably, the recess is mounted on one or more flanges or stops which extend upwardly from the base element when installed, the recess preferably disposed at a selected distance from an upper surface of the base element so that it may promote axial force in the top element, and inhibit the development of large bending stresses therein. The recess is preferably a notch in the shape of a V, open to a rear of the guitar so as to ease assembly and maintain tension in the guitar strings.

The pivoting element preferably includes a knife edge or wedge so as to inhibit the development of friction between the base and top elements when pivoting.

The base element may include a base plate which is adapted to mount to the deck by holes or means used to mount a bridge and/or a string retainer block, so as to facilitate retrofitting to guitars.

Preferably the base element is in the form of a base plate which comprises part of the pivoting joint as above described. The top element may include a top plate and comprises part of the pivoting joint as above described.

Preferably the top plate is adapted to mount a bridge and a string tension block apparatus thereon.

Preferably the top plate is fastened to the base plate having at least a portion thereof in a suspended disposition relative to the base plate, by the suspension apparatus. The suspension apparatus may include one or more spring assemblies to maintain a tension on the guitar strings. In one preferred embodiment the spring assembly includes a compression spring and a bolt which passes through the top plate and extends into a threaded fastener integral with or connected to the base plate. The bolt includes a washer which acts to hold the compression spring against the top plate. The bolt can be tightened or loosened easily from above the deck of the guitar by a user's fingers so as to selectively tension the guitar strings when they are mounted in the tensioning blocks. This action governs the maximum pitch bend of a note using the floating bridge.

A link plate may be provided which extends from one spring assembly to another so that the tightening of one bolt may affect the tension on all or the adjacent springs. This may provide a coarse tuning of all strings at once.

The arrangement of preferred embodiments provides a reduction in friction because of the fine point about which the top plate pivots. This improves the vibrato response by reducing decay of the vibrato. The assembly preferably provides a retrofittable floating bridge which can be installed using only the holes already present on a guitar for fitting a bridge and the string retainers.

An actuator plate may be provided so as to actuate vibrato response. The actuator plate is mounted to the top plate and generally is disposed parallel to the top plate in spaced relation thereto. The actuator plate is mounted on legs which fit in slots adjacent the spring assemblies and extends forward from outer ends of the legs therefrom.

According to another aspect of the present invention there is provided a guitar which includes a floating bridge apparatus including: a base element and a top element operatively connected to one another for relative movement therebetween which causes vibrato or like pitch-change in the strings, the base element mounted to a deck of the guitar; and a suspension apparatus for controlling the relative movement between the base and top elements, wherein the suspension apparatus is accessible from a position above the deck.

### BRIEF DESCRIPTION OF THE DRAWINGS

In order to enable a clearer understanding, preferred embodiments of the invention will hereinafter be described with reference to drawings and in those drawings:

FIG. 1 is a perspective view from one end of a floating bridge apparatus, which is a preferred embodiment of the present invention; and

FIG. 2 is a perspective view of the floating bridge apparatus of FIG. 1 from another direction.

### DETAILED DESCRIPTION OF THE PREFERRED EMBODIMENT

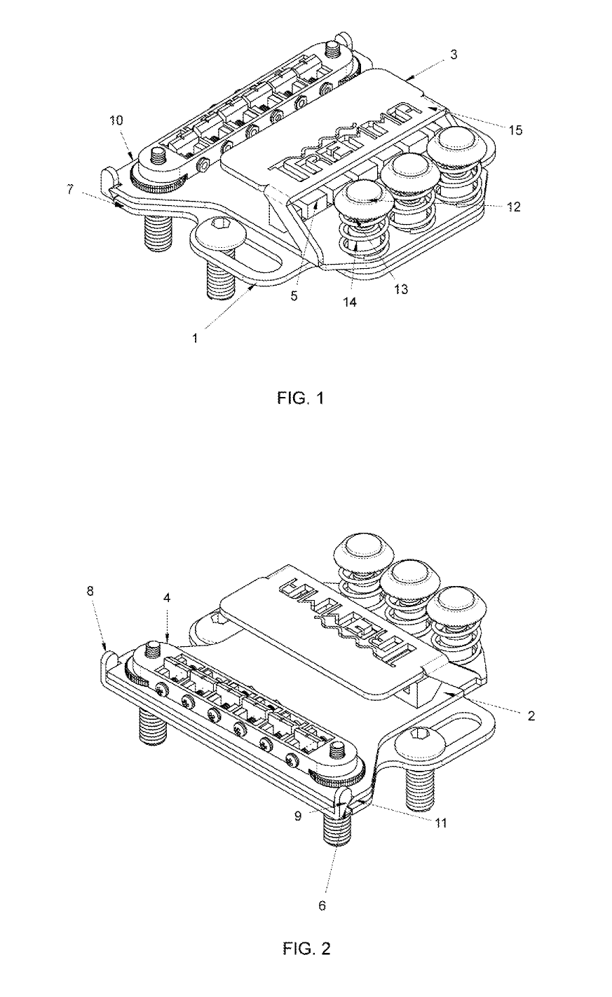

Referring to FIG. 1 there is shown a floating bridge apparatus which is mounted to a deck of a guitar. The floating bridge apparatus includes a base element 1 and a top element 2 which are operatively connected to one another for relative movement therebetween so as to cause vibrato or other note bending of one or more strings when a user is playing the guitar.

The guitar includes a bridge 4 and string retainer blocks 5, which are mounted on the top element 2.

The arrangement is such that the relative movement between the base 1 and top 2 elements is pivoting movement effected by a pivoting joint 6. The particular kind of pivoting movement is such that the top element 2 pivots about an axis which is disposed at a front edge region of the base element 1 and 2 and parallel to the frets on the fretboard (both not shown). That is, the base element 1 includes a base plate 7 and a stop 8 integral with and extending upwardly from the base plate 7 so that a pivot axis is defined generally parallel to and adjacent the bridge 4. The stop 8 is in the form of upstanding flanges which are turned up from the base plate 7 at the front edge region, the flanges including a recess open at a rear edge of the stop 8 thereof, the recess being in the form of a notch 9 for receiving the top element 2. Furthermore, the top element 2 includes a top or lever plate 10 and a knife edge 11 mounted in the front edge region for inserting into the notch 9. Therefore is a simple matter to maintain the strings in a tensioned state, by retaining a rear of the top or lever plate 10, and this is done in a manner described below.

Retention of the rear of the top or lever plate 10 is done in a floating manner which is effected by a suspension apparatus for controlling the relative movement between the top 10 and base plates 7. The suspension apparatus includes three spring assemblies, each including a bolt 12, washer 13 and spring 14, the bolt being received in a nutsert or a threaded hole (not shown) in base plate 7. A connector plate (not shown) may be provided under the washers 13 of each spring assembly so that adjustment of one bolt 12 may adjust all the spring assemblies. It will be appreciated that such an arrangement can quickly adjust tension of guitar strings.

An actuator plate 15 is provided to actuate the vibrato or other note bending of the strings. The actuator plate 15 is in the form of a palm plate 3 which is spaced above the strings and retention block 5.

While playing a song, the palm plate 3 is pushed and released rapidly by the heel of the user's hand so as to alter the pitch of the strings. This movement creates vibrato because the spring assemblies quickly return the top plate 10 to its original displacement. Advantageously, the knife edge 11 reduces friction of the pivoting movement of the top or lever plate 10. Furthermore, the accessibility of the springs 14 makes for easy adjustment and replacement of the springs, and the base plate 7 simply bolts onto the holes which are provided for the attachment of the bridge 4 and spring retainer blocks. The apparatus has all components mounted above the base plate 7 so that no additional machining into the deck of the guitar is required to retrofit the apparatus. The tension on the springs 14 may be directly adjusted by turning the bolts 12. Furthermore, the line of action of the compression springs 14 is directly into the top or lever plate 10 which improves efficiency of the system, reducing friction and therefore improving vibrato response.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A floating bridge apparatus adapted to be mounted on a guitar having strings, the floating bridge apparatus including: a base element and a top element operatively connected to one another for relative movement therebetween which causes vibrato or like pitch-change in the strings, the base element mountable to a deck of the guitar; and a suspension apparatus for controlling the relative movement between the base and top elements, wherein the suspension apparatus is accessible from a position above the deck.

2. A guitar which includes a floating bridge apparatus including: a base element and a top element operatively connected to one another for relative movement therebetween which causes vibrato or like pitch-change in the strings, the base element mounted to a deck of the guitar; and a suspension apparatus for controlling the relative movement between the base and top elements, wherein the suspension apparatus is accessible from a position above the deck.
